(19) United States
(12) Patent Application Publication
(10) Pub. No.: US 2003/0162558 A1
(43) Pub. Date: Aug. 28, 2003

(54) Wireless communication device comprising a light emitting antenna

(75) Inventors: Manabu Takase, Kawasaki (JP); Shinsuke Shimahashi, Kawasaki (JP); Masaru Kanazawa, Kawasaki (JP); Yuji Kinuzawa, Sapporo (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/317,617

(22) Filed: Dec. 12, 2002

(30) Foreign Application Priority Data
Feb. 28, 2002 (JP) 2002-053948

(51) Int. Cl. H04B 1/00; H04B 1/06; H04B 7/00; H04M 1/00; H04B 1/38

(52) U.S. Cl. 455/550; 455/129; 455/575; 455/269

(57) ABSTRACT

A light emitting antenna of a cellular phone comprises an insulative guided light scattering/radiating member arranged within a transparent or translucent antenna top protection cap fixed with the main body portion. The surface of the guided light scattering/radiating member is made coarse, and a helical antenna is wound around and held by the main body portion. A light introducing portion is held by the antenna top protection cap. A light source is arranged in a position as opposed to an end surface of the guided light scattering/radiating member. Power of the light source is supplied from a battery without using a transmitted/received electric wave.

### BACKGROUND OF THE INVENTION

1. Field of the Invention

The present invention relates to a wireless communication device comprising a light emitting antenna, and more particularly, to a wireless communication device comprising a light emitting antenna which emits light by changing the color, the brightness, the illumination interval, etc. of emitted light according to the circumstances without exerting a bad influence on the characteristic of the antenna.

2. Description of the Related Art

Conventionally, a wireless communication device such as a portable wireless communication terminal, etc., whose antenna top is made to illuminate, is known.

FIG. 1A is a cross-sectional view showing the configuration of a light emitting unit of such a potable wireless communication terminal whose antenna top illuminates, whereas FIG. 1B schematically shows the circuit for explaining the mechanism of the light emission. As shown in FIGS. 1A and 1B, an antenna that is conventionally called an illuminating antenna is actually configured by a detecting circuit 3 connected to the top of an antenna 2 of a fixed or extending type, which is arranged within the portable wireless communication terminal (hereinafter referred to as a portable terminal), a light-emitting diode 4 connected to the detecting circuit 3, and a protection cap 5 protecting the entire top of the antenna which includes the light emitting diode 4 and the detecting circuit 3.

The detecting circuit 3 comprises two high-frequency detecting diodes 6a and 6b, which are mutually oriented in reverse directions and connected in parallel between the upper end of the antenna 2 and the light-emitting diode 4. The detecting circuit 3 diverts part 7 of an electric wave transmitted/received by the antenna 2 of the local device (portable terminal 1) with the two high-frequency detecting diodes 6a and 6b, converts the part of the electric wave into an electric current, and makes the light-emitting diode 4 emit light with the electric current.

Generally, for a portable terminal, a basic characteristic of an antenna, which is set as a standard, is demanded even in a weak electric field. Therefore, the basic characteristic of the antenna must be adjusted by using a helical structure or a matching circuit.

However, the above described structure for making the top of the antenna emit light forms the electric circuit for detecting part of an electric wave that is transmitted/received by the antenna and used for a power source of light emission. No matter how the basic characteristic of the antenna is adjusted, a transmission/reception state becomes unstable.

Furthermore, since the top of the antenna has the complex structure of comprising the two high-frequency detecting diodes and the light-emitting diode of high performance, which emits light with a very weak current, the reliability of the strength, etc. required for a portable terminal that is used under harsh environments such as a vibration, a physical shock, an extremely cold climate, etc., is not assured to be high.

Additionally, because the antenna has the structure of emitting light by detecting a very weak current, it detects the electric wave of a portable terminal of another person, and emits light.

Furthermore, light is emitted by simply using a transmitted/received electric wave. Accordingly, there is no change in the color, the brightness, or the illumination interval of emitted light, and a way of light emission is simple, which leaves a user wanting for more.

### SUMMARY OF THE INVENTION

An object of the present invention is to provide a wireless communication device having a light emitting antenna which can emit light and make notification by changing the color, the brightness, or the illumination interval of emitted light according to the state of a transmitted/received electric wave, the remaining amount of a battery, the proceeding status of a game, which is operated with an external input, etc., without exerting a bad influence on the characteristic of the antenna, in view of the above described conventional background.

To achieve this object, firstly, a wireless communication device is configured by comprising an antenna whose top emits light, and which comprises: an antenna top protection insulative cap having a transparent or translucent light guiding nature; a guided light radiating member that is arranged within said antenna top protection cap, and holds a helical antenna which is wound around; and a light source which is arranged close to a bottom of said guided light radiating member, comprises a light emission function independently of an electric wave transmitted/received by the antenna, and inputs light emitted from the light emission function to said guided light radiating member.

Additionally, a wireless communication device is configured by comprising an antenna whose top emits light, and which comprises: a tube-shaped antenna accommodating portion whose inner surface is processed to be a mirror; a light source arranged at a bottom end of said antenna accommodating portion; a stick antenna portion that is held, to be freely extended or retracted, by said antenna accommodating portion, comprises an insulative protection cap having a transparent or translucent light guiding nature at a top, and comprises an insulative guided light radiating member, which externally radiates input light from a surface, within the protection cap; and an optical fiber, which is included only within said stick antenna portion, light emitted from said light source or light reflected from the mirror of the inner surface of said antenna accommodating portion is input to, and guides and relays the input light to the guided light radiating member within the protection cap.

In any of the above described wireless communication devices, for, example, the light source may be configured by comprising two or more light-emitting elements whose emitted light colors are different. Or, the wireless communication devices may further comprise a control device controlling the color, the brightness, or the illumination interval of light emitted from said light source based on a preset program or an external instruction input operation. In this case, if the control device is configured by controlling the color, the brightness, or the illumination interval of the light emitted from the light source, for example, based on a transmitted/received electric wave state, the remaining amount of a battery, a time, and a communication duration of a local main body device, or proceeding status of a game played by the local main body device, a variety of light emissions to which notification functions of various types are added can be implemented and enjoyed.

According to the present invention, a protection cap arranged, for example, at the top of a fixed helical antenna or an extensible stick antenna, and a guided light scattering/radiating member are insulative, a light guiding member arranged within the extensible stick antenna is an optical fiber which is also insulative, and a power source of a light source which supplies light to the guided light scattering/radiating member is a power source which is independent of an electric wave transmitted/received by the antenna. Therefore, even if light is emitted from the top of the antenna, it exerts no bad influence on the characteristic of the antenna, and does not degrade the characteristic of the antenna. Accordingly, comfort by light emission, and transmissions/receptions that are always stable can be realized, which affords convenience.

Additionally, a light source is fixed at the bottom of an antenna accommodating unit of an extensible stick antenna, and light is relayed by the antenna accommodating unit itself, with the use of an inner surface mirror, from the light source to a guided light scattering/radiating member at the top of the antenna with no waste. Therefore, the structure of the entire antenna is simple and its arrangement space can be saved although the antenna is an extensible stick type. This contributes to the down sizing of the main body of a wireless communication device comprising an extensible stick antenna whose top emits light.

Furthermore, since a power source of a light source which supplies light to a guided light scattering/radiating member is independent of an electric wave transmitted/received by an antenna, the color, the brightness, or the illumination interval of light emitted from the light source can be arbitrarily controlled regardless of the state of an electric wave, and communication status. As a result, a notification can be made to a user by controlling the color, the brightness, the illumination interval, etc. of light emitted from the light source, for example, according to the state of a transmitted/received electric wave, the remaining amount of a battery, the proceeding status of a game, etc. This affords convenience to the user.

### BRIEF DESCRIPTION OF THE DRAWINGS

FIG. 1A is a cross-sectional view showing the configuration of a light emitting unit of a conventional portable wireless communication terminal whose antenna top illuminates;

FIG. 1B schematically shows the circuit for explaining the mechanism of the light emission;

FIG. 2A is a front view schematically showing the outward appearance of a portable wireless phone according to a first preferred embodiment;

FIG. 2B shows its rear view;

FIG. 3A is a cross-sectional view showing the internal configuration in the proximity of an antenna top protection cap in the first preferred embodiment;

FIG. 3B is a perspective view showing its disassembled configuration;

FIG. 4A is a cross-sectional view showing a variation of the internal configuration in the proximity of the antenna top protection cap in the first preferred embodiment;

FIG. 4B is a perspective view showing its disassembled configuration;

FIG. 5 shows the state of changes (degradations) in the characteristic of an antenna in the case of light emission using not a transmitted/received electric wave but a different light source, and in the case of conventional light emission using a transmitted/received electric wave;

FIG. 6A shows the state of a stick antenna when being retracted in a second preferred embodiment;

FIG. 6B shows the state of the stick antenna when being extended;

FIG. 7A takes and shows an extended antenna portion in the second preferred embodiment;

FIG. 7B is a cross-sectional view showing the internal configuration of the top;

FIG. 7C is an enlarged perspective view showing the end of the extended antenna portion;

FIGS. 8A and 8B exemplify a method processing the inside of an antenna accommodating unit to be a mirror in the second preferred embodiment;

FIGS. 8C and 8D exemplify another method processing the inside of the antenna accommodating unit to be a mirror;

FIG. 9 is a block diagram schematically showing a control system having the configurations in the first and the second preferred embodiments;

FIGS. 10A, 10B, and 10C respectively show the data structures of parameters of various types, which are stored in a data storing unit of a memory unit, for controlling a light emission of a light source in the control system in a variety of ways;

FIG. 11 schematically shows the process for allocating a combination of data of three types such as (1) color, (2) illumination time, and (3) brightness (LED-driven current), which is performed by a CPU of the control unit; and

FIGS. 12A and 12B show another preferred embodiment of the extensible antenna.

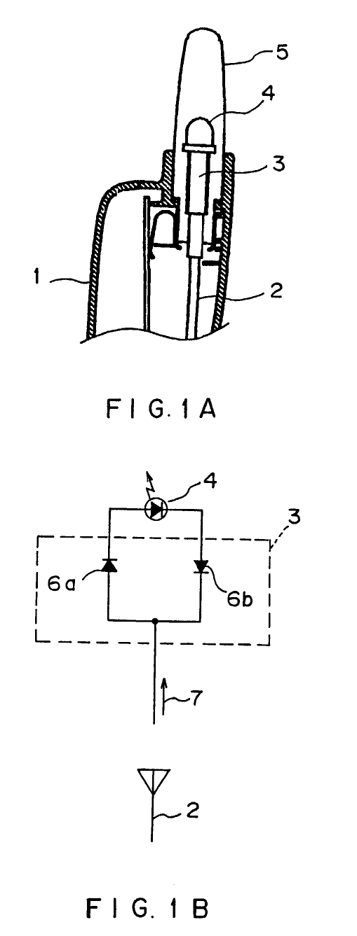

### DESCRIPTION OF THE PREFERRED EMBODIMENTS

Hereinafter, preferred embodiments according to the present invention are explained with reference to the drawings;

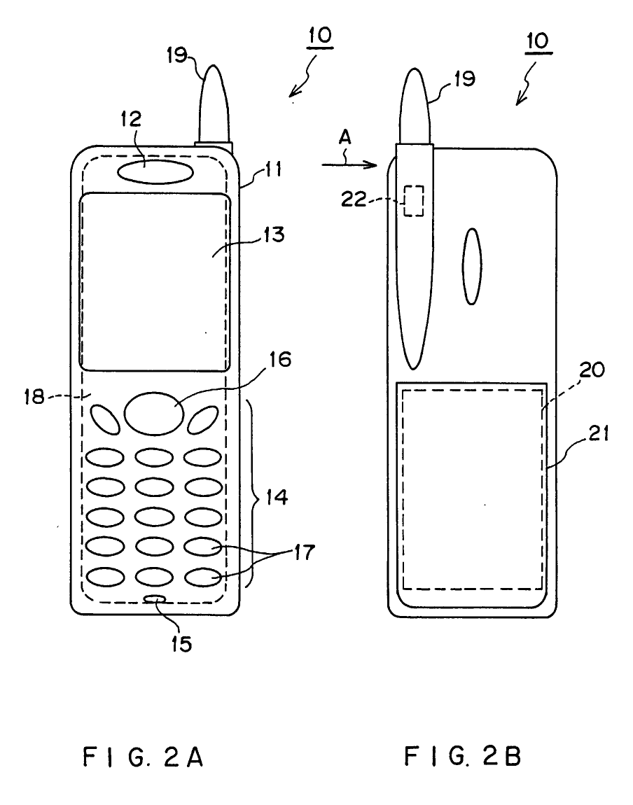

FIG. 2A is a front view schematically showing the outward appearance of a portable wireless phone according to a first preferred embodiment, whereas FIG. 2 shows its rear view. As shown in FIG. 2A, for a portable wireless phone (hereinafter referred to as a cellular phone), a speaker 12 is arranged in the upper portion of the front of a main body 11, and a liquid crystal display device 13, which occupies almost the upper half of the front, is arranged below the speaker 12.

An operation unit 14, which occupies almost the lower half of the front, is arranged below the liquid crystal display device 13, and a mike 14 is arranged at the bottom. On the operation unit 14, a plurality of operation buttons 17 for inputting a numeral, a character, and an instruction are arranged in addition to a cursor-cum-setting key 16. Within the cellular phone, a circuit substrate 18 comprising a control unit to be described later is arranged close to the front of the main body 11, and electrode terminals of the above described units are connected to predetermined electrode terminals of the circuit substrate 18.

Additionally, as shown in FIG. 2B, an antenna top protection cap 19, which is externally projects in an upward direction from the top of the rear, is arranged, and a cover 21 of an internal battery accommodating unit 20, which occupies almost the lower half of the rear, is arranged. The battery accommodating unit 20 accommodates a rechargeable battery or a commercially available battery. Furthermore, a light source 22 to be described in detail later is arranged in the proximity of the bottom of the antenna top protection cap 19 within the rear.

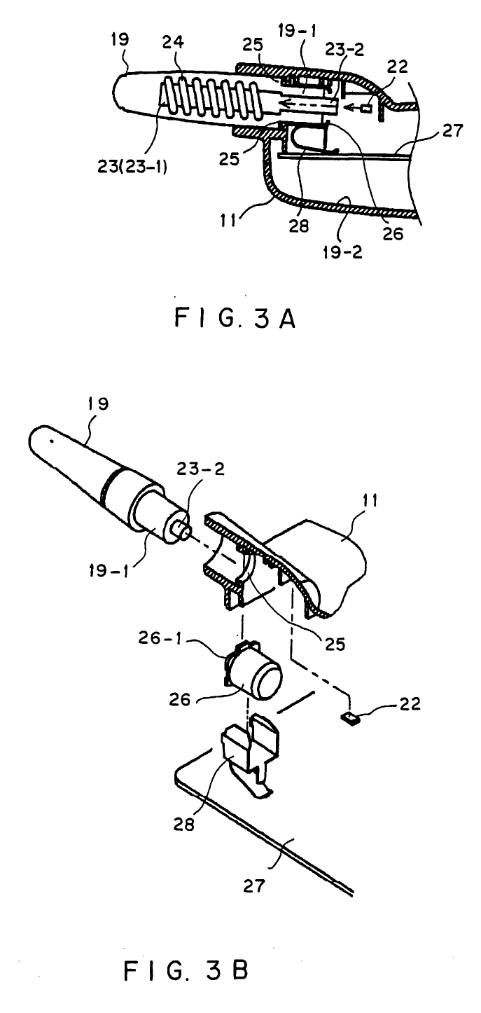

FIG. 3A is a cross-sectional view showing the internal configuration in the proximity of the antenna top protection cap 19 shown in FIG. 2B when viewed from the direction of an arrow A, whereas FIG. 3B is a perspective view showing its disassembled configuration. The antenna top protection cap 19 shown in FIGS. 3A and 3B is configured by, for example, an insulative member of a suitable synthetic resin, which has a transparent or translucent light guiding nature. The antenna top protection cap 19 accommodates and holds a guided light scattering/radiating member 23 of an insulative nature in its hollow portion.

The guided light scattering/radiating member 23 is composed of a main body portion 23-1 that is formed to be relatively thick, and a held and light introducing portion 23-2 that is formed to be thinner than the main body portion 23-1. The surface of the main body portion 23-1 is made coarse, for example, by a sandblasting technique, although this is not particularly shown. Light input from the held and light introducing portion 23-2 to the inside is diffusely reflected on the surface of the main body portion 23-1, and externally radiated while being scattered.

If the surface of the main body portion 23-1 is formed to be a crystal glass, the light scatters coarsely, and gives a hard and brilliant impression due to the coarse surface by the cut. In the meantime, the light scatters finely and gives a soft impression, if the surface of the main body portion 23-1 is formed to be coarse by a sandblasting technique. However, there is no difference in the structure of diffusely reflecting, scattering, and externally radiating the light which is input to the inside.

A helical antenna 24 is wound around and held by the coarse surface of the main body portion 23-1 of the guided light scattering/radiating member 23-1. The held and light introducing portion 23-2 is penetrated in and held by a hollow portion of a portion 19-1 interlocking with the main body (cellular phone 10), which is shaped like a projected cylinder at the bottom end of the antenna top protection cap 19.

In the embodiment shown in FIG. 3, the outer end of the held and light introducing portion 23-2 of the guided light scattering/radiating member 23 is arranged to slightly project external to the end surface of the interlocking portion 19-1 of the antenna top protection cap 19.

It is desirable that the guided light scattering/radiating member 23 is a material which scatters and diffusely reflects light. However, the guided light scattering/radiating member 23 is not limited to this implementation, and may be a material which only makes light pass through.

Additionally, a lead is externally extended from the bottom end of the helical antenna 24 along with the held and light introducing portion 23-2 of the guided light scattering/radiating member 23, although this is not shown.

A protection cap holding portion 25, which is shaped like a circle, is formed for the main body 11. A cylindrical holding member 26, which is configured by a conductive member and has a petal-shaped flange 26-1, is penetrated in the protection cap holding portion 25 from upward, so that the protection cap holding portion 25 is positioned by the flange 26-1.

The interlocking portion 19-1 of the antenna top protection cap 19 is penetrated in the holding member 26 as shown in FIG. 3A, so that the antenna top protection cap 19 is held by the protection cap holding portion 25 of the main body 11 via the holding member 26.

Additionally, one end of a conductive spring board 27 is arranged between the holding member 26 and a front interior wall 11-1 of the main body 11, whereas the other end of the conductive spring board 27 is extended beyond FIG. 3 in the right direction, and connected to a predetermined terminal of the circuit substrate 18 shown in FIG. 2A. On the rear of the one end of the conductive spring board 27, a conductive supporting member 28, where an upper supporting portion whose cross section is U-shaped and a lower supporting portion whose cross section is C-shaped are integrated, is arranged by fixing the bottom end of the lower supporting portion whose cross section is C-shaped to the one end of the rear of the conductive spring board 27.

The holding member 26, which is held by the protection cap holding portion 25 and projects inside the main body 11, interlocks with the upper supporting portion whose cross section is U-shaped of the supporting member 28, so that the holding member 26 is more securely held by the side of the main body 11. At the same time, the lead of the helical antenna 24, which is externally extended along with the held and light introducing portion 23-2 of the guided light scattering/radiating member 23, is connected to a predetermined terminal of the circuit substrate 19 via the holding member 26, the supporting member 28, and the conductive spring board 27. This connection makes the helical antenna 24 serve as an antenna.

Additionally, a light source 22 is arranged in a position that is close to the bottom end which projects externally (in the internal direction of the main body 11) from the holding member 26 of the held and light introducing portion 23-2 of the guided light scattering/radiating member 23, and as opposed to the bottom end. The light source 22 is connected to a predetermined terminal of the circuit substrate 18 with a wire not shown, power is supplied from the battery of the battery accommodating unit 20 via the control unit.

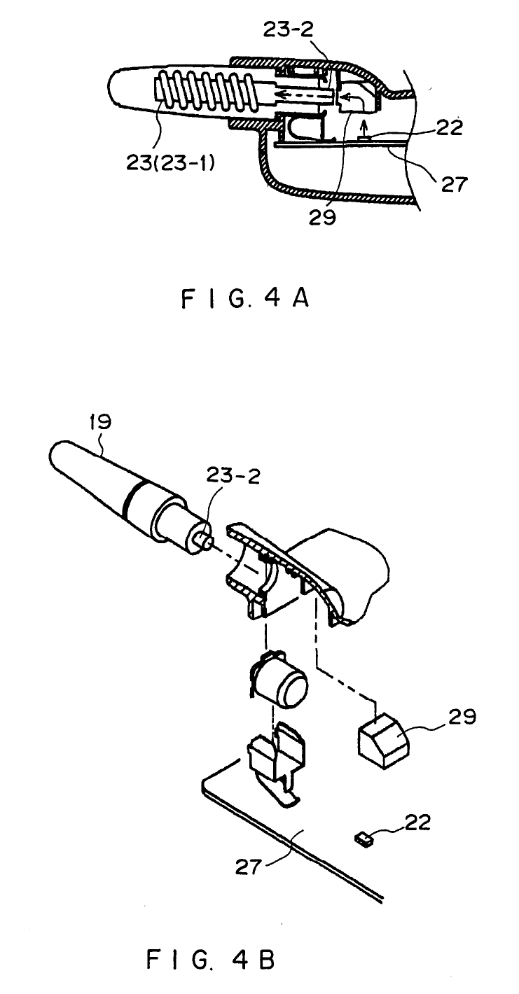

FIG. 4A is a cross-sectional view exemplifying a variation of the above described configuration, whereas FIG. 4B is a perspective view showing its disassembled configuration. Constituent elements of the configuration shown in FIGS. 4A and 4B are the same as those of the configuration shown in FIGS. 3A and 3B except that a position in which the light source 22 of the configuration shown in FIGS. 3A and 3B is arranged is different, and a gathered/polarized light radiating unit 29 is added.

Namely, as shown in FIGS. 4A and 4B, the gathered/polarized light radiating member 29 is arranged in the position of the light source 22 in FIG. 3 so that its radiating surface is as opposed to the bottom end of the held and light introducing portion 23-2 of the guided light scattering/radiating member 23.

The light source 22 is arranged by being fixed in the position as opposed to the light gathering surface of the gathered/polarized light radiating member 29 on the conductive spring board 27. Light emitted from the light source 23 is input to the light gathering surface of the gathered/polarized light radiating member 29. This input light is polarized in its proceeding direction within the gathered/polarized light radiating member 29, and the polarized light is output from the radiating surface to the bottom end of the held and light introducing portion 23-2 of the guided light scattering/radiating member 23. As a result, the light, which is input to the bottom end of the held and light introducing portion 23-2 of the guided light scattering/radiating member 23, is externally radiated from the surface of the main body portion 23-2 while being scattered, and externally radiated from the antenna top protection cap 19.

In all of the above described configurations, power is supplied from a power source battery to the light source 22 via the control unit, which will be described later, independently of a transmitted/received electric wave. Therefore, the light emitted from the light source 22 exerts no influence on the characteristic of the antenna 24.

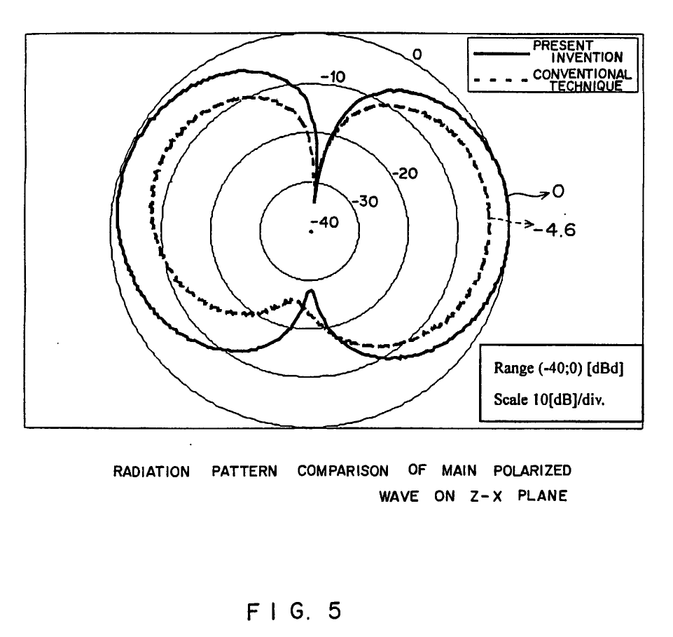

FIG. 5 shows the state of changes (degradations) in the characteristic of the antenna in the case of light emission using not a transmitted/received electric wave but a different light source, and in the case of conventional light emission using a transmitted/received electric wave. FIG. 5 shows an electric wave radiation pattern of a main polarized wave on a Z-X plane of an antenna to be tested (the antenna 24 according to the present invention or the antenna 2 having the conventional structure) against a pattern of a reference antenna for a test. Circles shown in FIG. 5 represent a scale by 10 dB/div. The position of the central point represents “−40 dB”, the position of the minimum circle around the central point represents “−30 dB”, and circles which become larger toward the outside sequentially represent “−20 dB”, “−10 dB”, and “0 dB”.

As indicated by a wavy spread of a solid line in FIG. 5, the antenna 24 according to the present invention maintains “0 dB” in the maximum range regardless of light emission. In the meantime, as indicated by a broken line in FIG. 5, the characteristic of the conventional antenna 2 exhibits a degradation by 4.6 dB at the time of light emission.

In the above described first preferred embodiment, the antenna of the fixed type is adopted also in the variation example. However, also for an extensible stick antenna, which is accommodated by an antenna accommodating unit comprised within the main body, and used by being externally extended, its top can be made to emit light by driving a power source independently of a transmitted/received electric wave in a similar manner as in the above described preferred embodiment.

Normally, if attempts are made to make the top of an extensible stick antenna emit light with a power source different from a method using a transmitted/received electric wave, a wire must be installed from the top to the power source, which supplies power to a light emitter at the top, within the stick antenna.

Not only the wire can possibly exert a bad influence, but also the arrangement space of an entire antenna accommodating portion becomes large. This is because also a wiring portion, which runs within the antenna accommodating portion from the bottom of the stick antenna, must be retracted by being folded when the stick antenna is accommodated within the antenna accommodating portion. Furthermore, folding and extension forces, which are alternately applied to the wire each time the antenna is extended and retracted, become secular destroy forces, so that the wire can possibly be damaged earlier.

The extensible stick antenna according to the present invention has a configuration that has no predictable fear as described above. This antenna is described below as a second preferred embodiment.

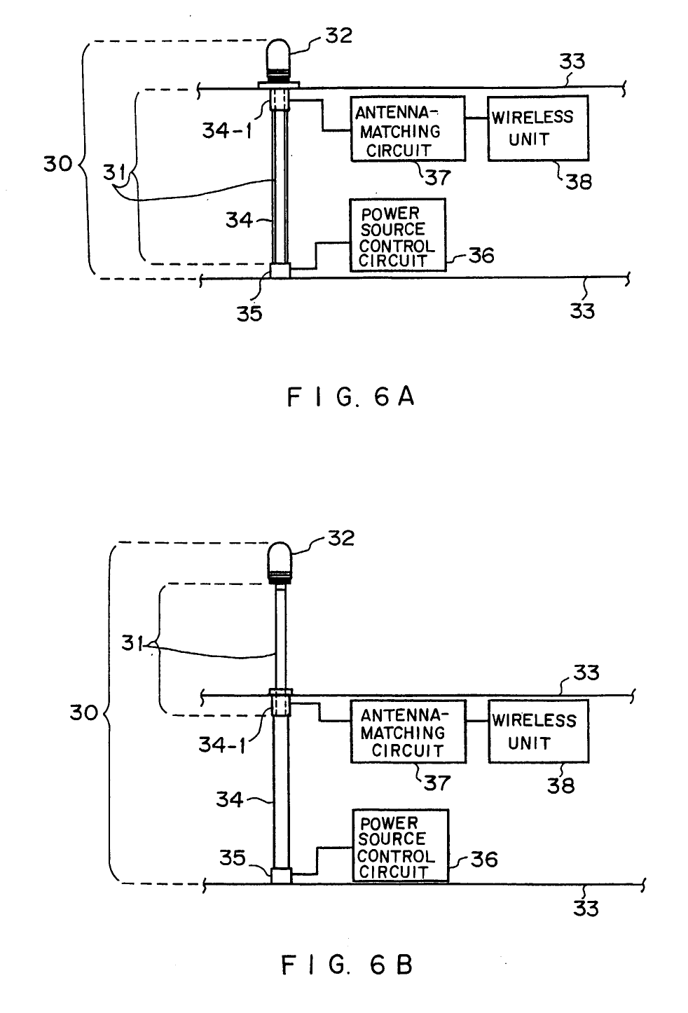

FIG. 6A shows the state of the stick antenna according to the second preferred embodiment when being retracted (when the stick antenna is accommodated by an antenna accommodating portion), whereas FIG. 6B shows the state of the stick antenna when being extended (when the stick antenna is extended from the antenna accommodating portion). The shape, the outward appearance, and the outline of the internal configuration of the main body device is almost the same as those of the portable wireless phone (cellular phone) 10 shown in FIGS. 2A and 2B except for the antenna portion.

As shown in FIGS. 6A and 6B, an extended antenna portion 31 of an antenna unit 30 comprises a transparent or translucent top protection cap 32 at its top, and its body portion is held, to freely ascend and descend, by a holding unit 34-1 of a conductive antenna accommodating unit 34 fixed to a main body 33. The antenna accommodating unit 34 is a thin tube like a straw, and its inner surface is processed to be a mirror. At the bottom of the antenna accommodating unit 34, a light source 35 is fixedly arranged. A power source control circuit 36, which controls the light source 35 independently of the electric wave transmitted/received by the antenna unit 30, is connected to the light source 35.

Additionally, an antenna-matching circuit 37 is connected to the holding unit 34-1 that not only holds the extended antenna portion 31 but also electrically connects the extended antenna portion 31 and the antenna accommodating unit 34. The antenna-matching circuit 37 is connected to a wireless unit 38 of the control unit to be described later. The antenna-matching circuit 37 is a circuit which makes an adjustment to maintain the impedance of a communication circuit of a transmitted/received electric wave to be, for example, 50 Ω.

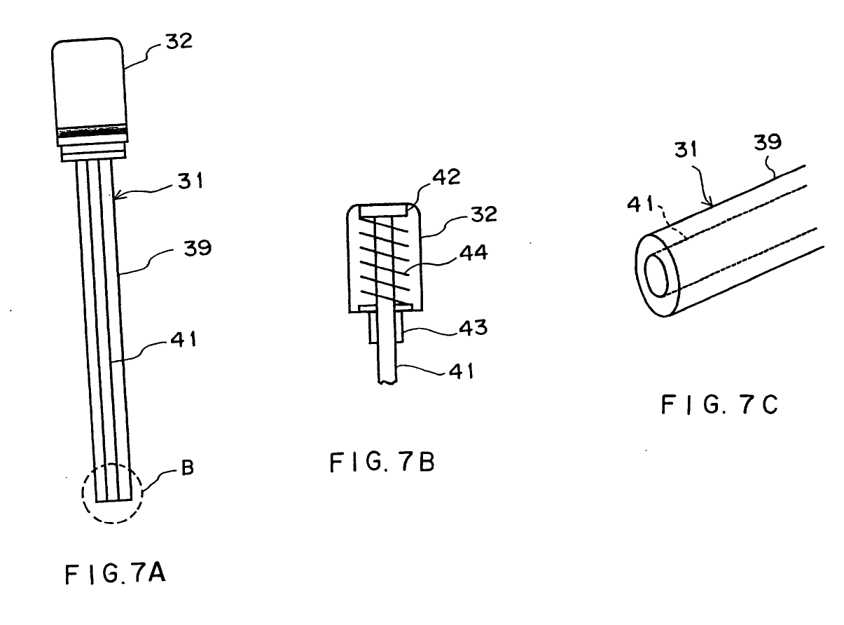

FIG. 7A takes and shows the above described extended antenna portion 31, FIG. 7B is a cross-sectional view showing the internal configuration of the top 32 of the extended antenna portion 31, and FIG. 7C is an enlarged perspective view of the end portion of the extended antenna portion 31, which is indicated by a broken line circle B shown in FIG. 7A. As shown in FIG. 7A, an optical fiber 41 is penetrated into a stick antenna 39 of the extended antenna portion 31.

The top end of the optical fiber 41 is linked to a disc-shaped guided light scattering/radiating member 42 which is arranged at the tip of the top protection cap 32, as shown in FIG. 7B. The surface of the guided light scattering/radiating member 42 is processed similarly to the guided light scattering/radiating member 23 shown in FIGS. 3 and 4. Although the guided light scattering/radiating member 42 takes the shape of a disc in FIG. 7B, it may be shaped like a stick as shown in FIGS. 3 and 4.

Furthermore, within the top protection cap 32, a helical antenna 44 is arranged between a conductive link member 43 at the bottom end and the guided light scattering/radiating member 42, and electrically connected to the stick antenna 39 via the conductive link member 43. The optical fiber 41 penetrates into the hollow portion of the helical antenna 44, and is linked to the guided light scattering/radiating member 42.

The bottom end of the optical fiber 41 is cut on the same plane as the bottom end of the stick antenna 39 of the extended antenna portion 31 as shown in FIG. 7C.

When the extended antenna portion 31 shown in FIG. 6A is retracted in this configuration, the bottom end of the optical fiber 41 contacts the light source 35, light emitted from the light source 35 is directly guided to the inside of the fiber, and the guided light is relayed to the guided light scattering/radiating member 42 of the top protection cap 32. In this way, the light emitted from the light source 35 is externally scattered and diffused from the guided light scattering/radiating member 42 in all directions, and externally radiated from the top protection cap.

Additionally, the light emitted from the light source 35 includes light which directly enters the bottom end of the optical fiber 41, and light which proceeds upward while repeatedly reflecting on the mirror of the inner surface of the conductive antenna accommodating unit 34, and finally enters the bottom end of the optical fiber 41. In either case, the light emitted from the light source 35 is input to the bottom end of the optical fiber 41 with almost no waste although a loss somewhat occurs, when the extended antenna portion 31 shown in FIG. 6B is extended.

Accordingly, also in this case, the light emitted from the light source 35 is relayed to the guided light scattering/radiating member 42 of the top protection cap 32 by the optical fiber 41, externally scattered and diffused from the guided light scattering/radiating member 42 in all directions, and externally radiated from the top protection cap 32.

Regardless of whether the antenna is either retracted or extended, power is supplied from the battery of the power source to the light source 35 via the control unit independently of a transmitted/received electric wave. Therefore, the light emitted from the light source 35 never exerts a bad influence on the characteristic of the antenna. Besides, not a wire which supplies power for light emission, but the optical fiber, which does not have a factor to disorder an electromagnetic field and simply guides light, makes the guided light scattering/radiating member 42 emit light. Therefore, no bad influence is exerted on the characteristic of the antenna. Namely, this light emitting antenna structure has a structure not to make the characteristic of the antenna degrade in every respect.

Additionally, wires for extending or folding are not required to extend and retract the extended antenna portion 31. Therefore, the portable wireless phone has an advantageous configuration also from the viewpoint of weight, space, and cost reductions, durability, etc.

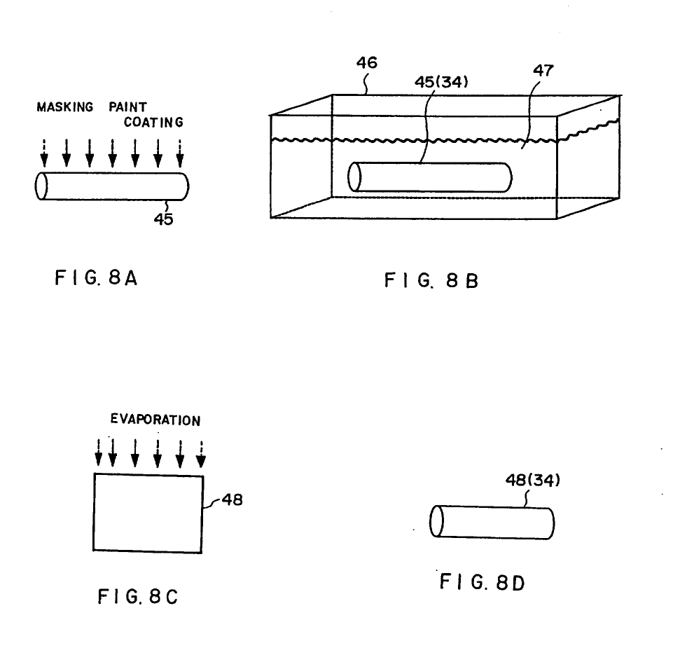

FIGS. 8A and 8B exemplify a method processing the inner surface of the antenna accommodating unit 34 to be a mirror, whereas FIGS. 8C and 8D exemplify another method. In the example shown in FIGS. 8A and 8B, after a conductive tube member like a straw is first prepared and cut to a desired length, a masking paint is coated on the outer surface of the conductive member 45 to prevent the outer surface from being processed as a mirror beforehand.

Then, as shown in FIG. 8B, the masked conductive member 45 is soaked in a plating bath where a plating solution such as a nickel solution, etc. is filled, so that a nickel thin film is formed on the inner surface of the conductive member 45 by electroless plating. In this way, the stick antenna 39 is generated with the conductive member 45 whose inner surface is processed to be a mirror of the nickel thin film.

Note that the plating may be the above described electroless plating, or plating implemented by ion-dissolving a plating material in an electrolytic solution and by using an electrode.

In the example shown in FIGS. 8C and 8D, a conductive board member 48 of a desired size is first prepared, and a mirror surface is formed by evaporating, for example, a thin film of nickel, etc. onto one surface of the conductive board member 48, for example, with a vacuum evaporation method, etc., as shown in FIG. 8C. Thereafter, the conductive board member 48 is rolled into a cylindrical shape so that the mirror surface of the nickel thin film becomes the inner side, and its ends are connected with solder, etc. Also in this case, the antenna accommodating unit 34 where the mirror surface of the nickel thin film is formed on the inner surface is generated as shown in FIG. 8D.

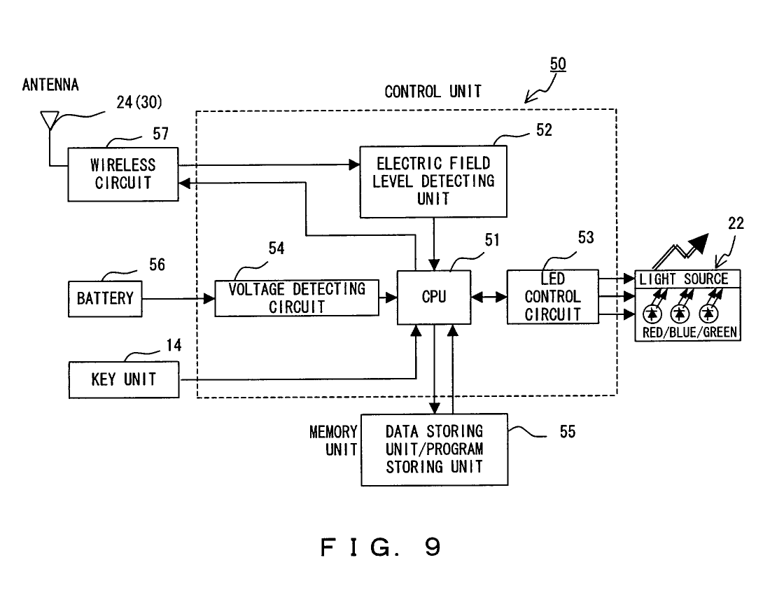

FIG. 9 is a block diagram schematically showing a control system having the configurations according to the above described preferred embodiments 1 and 2. A control unit 50 shown in this figure is configured by electronic components of various types mounted on the circuit substrate 18 shown in FIG. 2. Namely, the control unit 50 is composed of a CPU 51, an electric field level detecting unit 52 connected to the CPU 51 via a bus, a LED control circuit 53, and a voltage detecting circuit 54.

Additionally, the cursor-cum setting key 16 and the operation buttons 17 of the operation unit 14, which are shown in FIG. 2, are connected to the CPU 51 via wires. An event driven by an input operation with the key or the buttons is input to the CPU 51.

Furthermore, a memory unit 55 composed of a ROM, a RAM, etc. is connected to the CPU 51. The memory unit 55 comprises at least a data storing unit and a program storing unit. The program storing unit stores a control program which controls the whole of the system, prestores a program for controlling the light emission of the light source 22, or stores a program set by an input operation with the key of the operation unit 14. The data storing unit stores data of various types, which will be described in detail later, as parameters required for the program which controls the light emission of the light source 22.

Furthermore, the voltage detecting circuit 54 is a circuit which converts the power took out from a battery 56 accommodated by the battery accommodating unit 20 shown in FIG. 2 into power of a voltage of a suitable type, and supplies the converted power to the CPU 51. The CPU 51 outputs a control signal to the respective units by using this power, and drives and controls the units.

The electric field level detecting unit 52 is connected to a wireless circuit 57 on the other side. The wireless circuit 57 is the antenna-matching circuit 37 and the wireless unit 38, which are omitted in FIGS. 3 and 4 but shown in FIGS. 6A and 6B. The electric field level detecting unit 52 detects the level of an external electric field input to the antenna 24 (or 30: the same is applied hereinafter) via the wireless circuit 57, and notifies the CPU 51 of a detection result.

Based on the detection result input from the electric field level detecting unit 52, the CPU 51 controls the wireless circuit 57 to maintain the impedance to be, for example, 50 Ω. At the same time, the CPU 51 makes the LED control circuit 53 to control the light emission of the light source 22 by issuing an instruction to the LED control circuit 53.

The light source 22 in this preferred embodiment comprises three light-emitting diodes such as a red light-emitting diode emitting red-color light, a blue light-emitting diode emitting blue-color light, and a green light-emitting diode emitting green-color light.

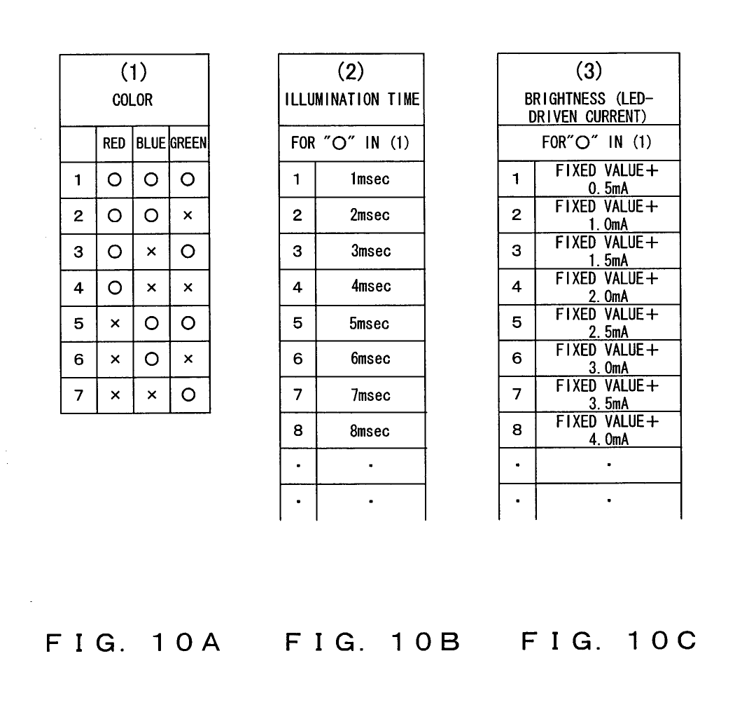

FIGS. 10A, 10B, and 10C exemplify the data structures of parameters of various types stored in the data storing unit of the memory unit 55 so as to control the light emission of the light source 22 in a variety of ways.

Firstly, data of “(1) color” shown in FIG. 10A represent combinations of illuminating the above described red, blue, and green light-emitting diodes. The number of combinations is 7 in total. The first piece of data is “∘∘∘”, which represents that all of the three light-emitting diodes, namely, the red, the blue, and the green light-emitting diodes are illuminated.

The second piece of data is “∘∘×”, which represents that the red and the blue light-emitting diodes are illuminated. The third piece of data is “∘×∘”, which represents that the red and the green light-emitting diodes are illuminated. The fourth piece of data is “∘××”, which represents that only the red light-emitting diode is illuminated.

Additionally, the fifth piece of data is “×∘∘”, which represents that the blue and the green light-emitting diodes are illuminated. Furthermore, the sixth piece of data is “×∘×”, which represents that only the blue light-emitting diode is illuminated. The seventh piece of data is “××∘”, which represents that only the green light-emitting diode is illuminated.

Data of “(2) illumination time” shown in FIG. 10B indicates an illumination time of the light-emitting diode represented by “∘” within the data of “(1) color”. Illumination times are set so that they sequentially become longer by 1 msec, for example, in a way such that the first piece of data is “1 msec (1 millisecond)”, the second piece of data is “2 msec”, and the third piece of data is “3 msec”.

Data of “(3) brightness (LED-driven current) set the level of brightness relative to a predetermined reference value of the light-emitting diode represented by “∘” within the data of “(1) color” with a current value which drives the light-emitting diode.

Namely, brightness levels are set so that driven currents sequentially become larger by 0.5 mA, that is, the brightness levels become higher, for example, in a way such that the first piece of data is “fixed value+0.5 mA”, the second piece of data is “fixed value+1.0 mA”, and the third piece of data is “fixed value+1.5 mA”.

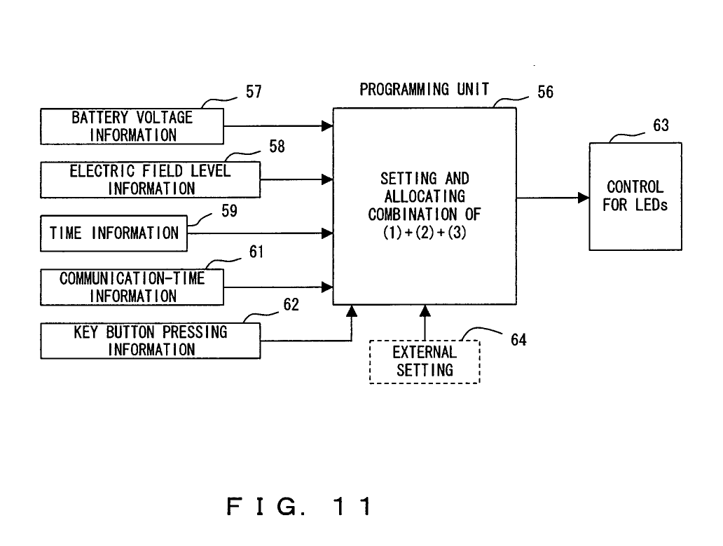

FIG. 11 schematically shows the process for allocating a combination of data of the three types such as “(1) color”, “(2) illumination time”, and “(3) brightness (LED-driven current), which is performed by the CPU 51 shown in FIG. 9. A programming unit 56 shown in FIG. 11 is configured by the CPU 51 and the memory unit 55, which are shown in FIG. 9.

Additionally, battery voltage information 57 shown in FIG. 11 is information input from the voltage detecting circuit 54 shown in FIG. 9, electric field level information 58 is input from the electric field level detecting unit 52, time information 59 is input from a clock circuit not shown, and communication-time information 61 is input from the wireless circuit 57 via the electric field level detecting unit 52.

Key button pressing information 62 is an event input from the key unit 14. With this event, a combination of data of the above described three types is arbitrarily selected and allocated in correspondence with the states of the battery voltage information 57, the electric field level information 58, the time information 59, the communication-time information 61, etc.

Furthermore, an external setting 64 indicates the state where a program, in which allocation of a combination of data of the above described three types is preset, is input from a host such as a personal computer, etc., which is connected with a dedicated cord, to the memory unit 55.

As described above, a combination of data of the three types is arbitrarily selected and allocated in correspondence with the states of the battery voltage information 57, the electric field level information 58, the time information 59, the communication-time information 61, etc., so that a control 63 for the light-emitting diodes (LEDs) is performed based on this allocation. With the control 63 for the LEDs, a predetermined driving current is output from the LED control circuit 53 to the light source 22 based on the control of the CPU 51 shown in FIG. 9.

In this way, light of an arbitrary color can be emitted from the antenna top at various level of brightness at various illumination intervals.

With a recent cellular phone 10, a preinstalled game or a desired game downloaded from a network can be played. In this case, if a combination of data of the three types is allocated, for example, according to a score, an elapsed time, etc., the proceeding status and result of a game can be visually identified according to the color, the brightness, the illumination interval, etc. of light emitted from the antenna top, thereby building a more enjoyable game environment.

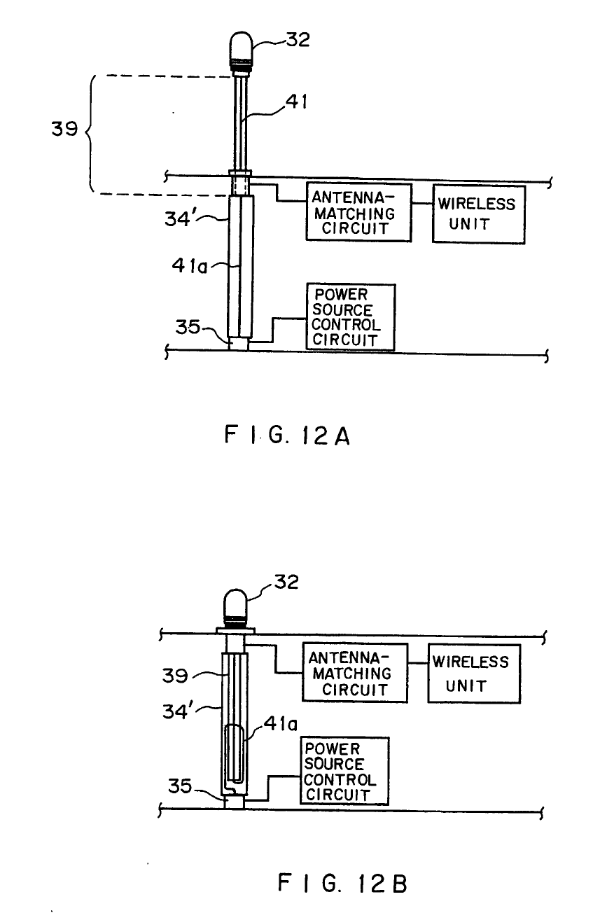

FIGS. 12A and 12B show another preferred embodiment of the extensible antenna. FIG. 12A shows the state of the extensible antenna when being extended, whereas FIG. 12B shows the state of the extensible antenna when being retracted. Structure of the stick antenna 39 is similar to that shown in FIG. 7. However, in this preferred embodiment, the internal optical fiber 41 is not cut at the bottom of the stick antenna 39 but extended, and its bottom end is directly linked to the light source 35.

Since the optical fiber 41 is extremely thin, it is flexible enough to be freely bent unless otherwise acutely bent. An optical fiber portion 41a, which extends from the bottom of the stick antenna 39 to the light source 35 as shown in FIG. 12A when the stick antenna 39 is extended, is accommodated within an antenna accommodating unit 34′ by being bent freely as shown in FIG. 12B when the stick antenna 39 is retracted.

Also in this case, the optical fibers 41 and 41a guide and relay the light emitted from the light source 35 to the guided light scattering/radiating member within the antenna top protection cap 32 regardless of whether the stick antenna 39 is either extended or retracted, whereby the light can be radiated from the antenna top protection cap 32 irrespective of whether or not the antenna is either extended or retracted.

Furthermore, no wires but only optical fibers exist within the antenna unit. Therefore, the light emitted from the light source never exerts a bad influence on the characteristic of the antenna also in this case.

What is claimed is:

1. A wireless communication device, comprising an antenna whose top emits light, wherein
the antenna comprises
an antenna top having a transparent or translucent light guiding nature,
a guided light radiating member that is arranged within said antenna top, and holds an antenna, and
a light source which is arranged close to a bottom of said guided light radiating member, and emits a light independently of an electric wave transmitted/received by the antenna, and inputs said light to said guided light radiating member.

2. A wireless communication device, comprising an antenna whose top emits light, wherein
the antenna comprises
a tube-shaped antenna accommodating portion whose inner surface is processed to be a mirror,
a light source arranged at a bottom end of said antenna accommodating portion,
a stick antenna portion that is held, to be freely extended or retracted, by said antenna accommodating portion, comprises a top portion having a transparent or translucent light guiding nature, and comprises guided light radiating member, which externally radiates input light from a surface, within the top portion, and
an optical fiber, which is included only within said stick antenna portion, light emitted from said light source or light reflected from the mirror of the inner surface of said antenna accommodating portion is input to, and guides and relays the input light to the guided light radiating member within the top portion.

3. The wireless communication device according to claim 1 or 2, wherein
said light source has two or more light-emitting elements whose emitted light colors are different.

4. The wireless communication device according to claim 1, 2, or 3, further comprising
a control unit controlling a color, brightness, or an illumination interval of light emitted from said light source based on a program or an external instruction input operation.

5. The wireless communication device according to claim 4, wherein
said control device controls the color, the brightness, or the illumination interval of the light emitted from said light source based on a transmitted/received electric wave state, a remaining amount of a battery, a time, and a communication duration of a local main body device, or proceeding contents of a game played by the local main body device.
